(19) United States
(12) Patent Application Publication
(10) Pub. No.: US 2013/0340091 A1
(43) Pub. Date: Dec. 19, 2013

(54) METHOD OF CREATING UI LAYOUTS WITH DESIRED LEVEL OF ENTROPY

(71) Applicants: Vinay Phegade, Beaverton, OR (US); Sanjay Bakshi, Portland, OR (US); Joseph Cihula, Hillsboro, OR (US); Jesse Walker, Portland, OR (US)

(72) Inventors: Vinay Phegade, Beaverton, OR (US); Sanjay Bakshi, Portland, OR (US); Joseph Cihula, Hillsboro, OR (US); Jesse Walker, Portland, OR (US)

(73) Assignee: Intel Corporation, Santa Clara, CA (US)

(21) Appl. No.: 13/976,022

(22) PCT Filed: Dec. 30, 2011
(86) PCT No.: PCT/US11/68183

§ 371 Date: Jun. 25, 2013

(51) Int. Cl. G06F 21/60

(52) U.S. Cl. CPC G06F 21/60
USPC 726/27

(57) ABSTRACT

A machine-controlled method can include visually presenting to a first user a first user interface for a first transaction involving user-sensitive information, the first user interface having a first user interface layout, and performing processing based on user-sensitive information received by way of user interaction by the first user with the first user interface. The method can also include visually presenting to a second user a second user interface for receiving a second transaction involving user-sensitive information, the second user interface having a second user interface layout that is visually distinct from the first user interface layout and has a desired level of entropy.

### TECHNICAL FIELD

The disclosed technology relates generally to user interfaces and, more particularly, to user interfaces providing increased protection from various types of security risks and attacks.

### BACKGROUND

The importance of security for user interfaces cannot be understated for a number of industries. For example, financial institutions generally strive to provide users with secure user interfaces for entry of passwords, credit card numbers, transaction-specific details, etc. Such interfaces also typically allow a user to view the true contents of certain transactions or documents, etc., that are specific to his or her account(s).

One of the current methods used to secure input and prove user presence is to simulate on-screen input devices such as PIN pads, virtual keyboards; and secret pictures. However, such simulations are still generally vulnerable to malware and may put user-sensitive information at risk for discovery by third parties. One of these attack vectors, for example, is an adversary, e.g., adverse or malicious third party, monitoring the channel between the PIN pad and the financial institution.

Thus, there a remains a need for improved security at user interfaces for greater protection from security risks and attacks.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 is a block diagram illustrating a first example of a current user interface layout including a PIN pad.

FIG. 2 is a block diagram illustrating a second example of a current user interface layout including a PIN pad.

FIG. 3 is a block diagram illustrating a first example of a user interface layout including a PIN pad in accordance with certain embodiments of the disclosed technology.

FIG. 4 is a block diagram illustrating a second example of a user interface layout representing a repositioning of the PIN pad and site information box in the layout of FIG. 3 in accordance with certain embodiments of the disclosed technology.

FIG. 5 is a block diagram illustrating a third example of a user interface layout including a PIN pad in accordance with certain embodiments of the disclosed technology.

FIG. 6 is a block diagram illustrating a fourth example of a user interface layout representing a repositioning of the PIN pad and site information box in the layout of FIG. 5 in accordance with certain embodiments of the disclosed technology.

FIG. 7 is a block diagram illustrating a fifth example of a user interface layout including a PIN pad in accordance with certain embodiments of the disclosed technology.

FIG. 8 is a block diagram illustrating a sixth example of a user interface layout representing a repositioning of the PIN pad and site information box in the layout of FIG. 7 in accordance with certain embodiments of the disclosed technology.

FIG. 9 is a block diagram illustrating a seventh example of a user interface layout including a PIN pad in accordance with certain embodiments of the disclosed technology.

FIG. 10 is a block diagram illustrating an eighth example of a user interface layout representing a repositioning of the PIN pad and site information box in the layout of FIG. 9 in accordance with certain embodiments of the disclosed technology.

FIG. 11 is a block diagram illustrating an example of a current site information box of a user interface in accordance with certain embodiments of the disclosed technology.

FIG. 12 is a block diagram illustrating a first example of a site information box of a user interface implementing a visual cue in accordance with certain embodiments of the disclosed technology.

FIG. 13 is a block diagram illustrating a second example of a site information box of a user interface implementing a visual cue in accordance with certain embodiments of the disclosed technology.

FIG. 14 is a block diagram illustrating an example of a user log-in interface in accordance with certain embodiments of the disclosed technology.

FIG. 15 is a block diagram illustrating a first example of a payment confirmation user interface in accordance with certain embodiments of the disclosed technology.

FIG. 16 is a block diagram illustrating a second example of a payment confirmation user interface in accordance with certain embodiments of the disclosed technology.

FIG. 17 is a block diagram illustrating a first example of a numeric keypad layout in accordance with certain embodiments of the disclosed technology.

FIG. 18 is a block diagram illustrating a second example of a numeric keypad layout in accordance with certain embodiments of the disclosed technology.

FIG. 19 is a block diagram illustrating a third example of a numeric keypad layout in accordance with certain embodiments of the disclosed technology.

FIG. 20 is a block diagram illustrating a fourth example of a numeric keypad layout in accordance with certain embodiments of the disclosed technology.

FIG. 21 is a flowchart illustrating an example of a machine-controlled method for providing a secure user interface in accordance with certain embodiments of the disclosed technology.

FIG. 22 illustrates an example of a system in which embodiments of the disclosed technology may be implemented.

### DETAILED DESCRIPTION

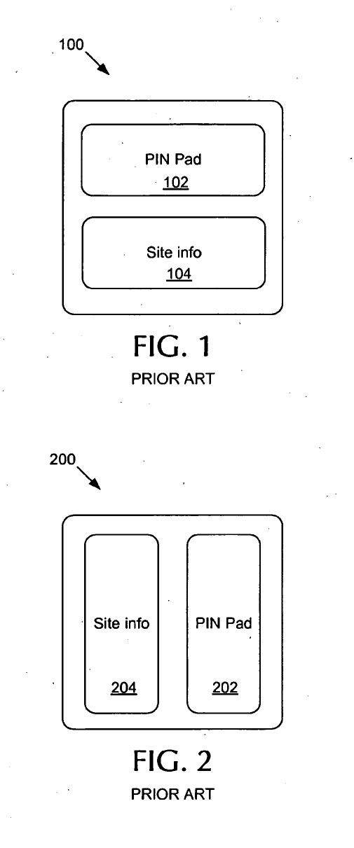

FIG. 1 is a block diagram illustrating a first example of a current user interface layout 100 including a PIN pad 102. The layout 100 also includes a site information box 104 configured to display information as entered by a user via the PIN pad 102. In the example, the PIN pad 102 and site information box 104 are substantially the same size and shape and are positioned in a vertical manner that is both aesthetically pleasing and easy to use because the layout 100 is generally static and, thus, predictable.

FIG. 2 is a block diagram illustrating a second example of a current user interface 200 layout including a PIN pad 202 and site information pad 204, such as the PIN pad 102 and site information box 104 in the layout 100 of FIG. 1. The layout 200 is similar to the layout 100 of FIG. 1 in that the PIN pad 202 and site information box 204 are substantially the same size and shape. The PIN pad 202 and site information box 204 are also statically positioned in a manner that is both aesthetically pleasing, easy to use, and predictable, but horizontally rather than vertically.

However, the benefits provided by the layouts 100 and 200 of FIGS. 1 and 2, respectively, as noted above, e.g., predictability, also have inherent shortcomings that can create or increase vulnerability to attacks. For example, because the PIN pads 102 and 202 and site information boxes 104 and 204 are presented in the same positions each time a transaction or other action occurs using either of the layouts 100 and 200, respectively, a third party can monitor certain locations of the layout 100 or 200 or insert a virtual overlap onto the layout 100 or 200 to capture information as it is entered by the user.

In order to distinguish between a secure display and information spoofed by malware, a secure window, e.g., for PIN pad buttons, can be randomized. For example, the position of certain interface elements, e.g., boxes for displaying sensitive and/or critical information, presented to a user relative to other interface elements, e.g., elements not pertaining to sensitive and/or critical information, may change after each user interaction, after each visit for a particular user, etc. As used herein, entropy refers to a technical measure of randomness, e.g., in bits. In embodiments of the disclosed technology, a user interface may have a layout including a PIN pad that is presented to the user in an unexpected and unpredictable configuration to prevent against an attacker associating certain mouse click locations or touchscreen areas with associated. PIN values entered by the user, for example.

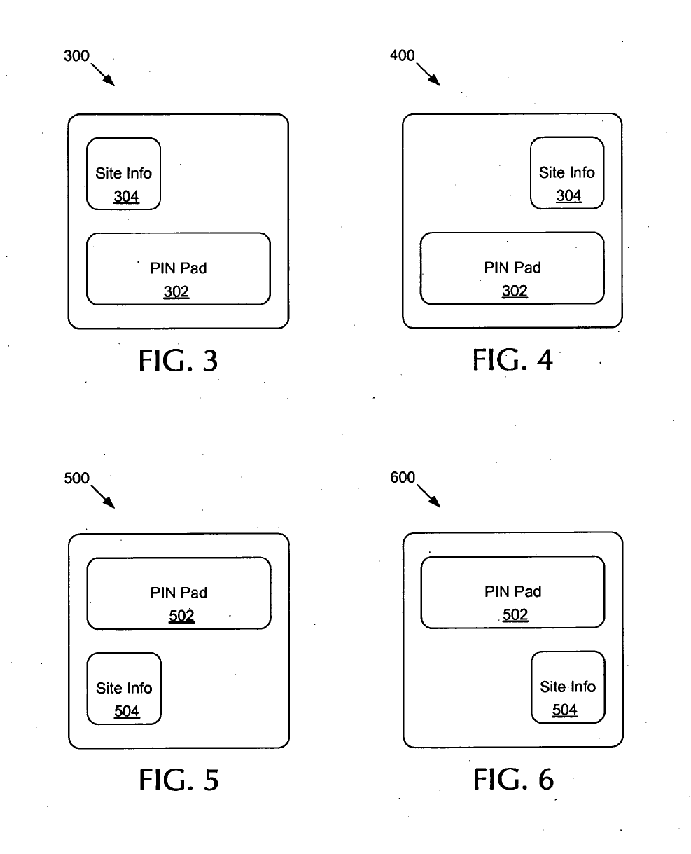

FIG. 3 is a block diagram illustrating a first example of a user interface layout 300 including a PIN pad 302 in accordance with certain embodiments of the disclosed technology. The PIN pad 302 may be a traditional button keypad, a touchscreen keypad, an audio input device such as a microphone, or virtually any input mechanism capable of receiving input from the user. The layout 300 also includes a site information box 304 configured to display information as entered by a user via the PIN pad 302. The layout 300 may be presented to a user via a traditional display, such as a monitor or computer screen, a display on a handheld device such as a tablet computer or smartphone, or an industry-specific device such as an airport kiosk or an automated teller machine (ATM).

FIG. 4 is a block diagram illustrating a second example of a user interface layout 400 representing a repositioning of the PIN pad 302 and site information box 304 in the layout 300 of FIG. 3 in accordance with certain embodiments of the disclosed technology. In situations where the layout 300 of FIG. 3 had been presented previously, e.g., for the last user interaction or for the last interaction for a particular user, the layout 400 of FIG. 4 may be subsequently presented instead of the layout 300 of FIG. 3, e.g., for the next user interaction or for the next interaction with a particular user.

As can be readily ascertained from looking at the layouts 300 and 400 of FIGS. 3 and 4, respectively, the PIN pad 302 remains in the same position but the site information box 304 has shifted horizontally. The ease of use is impacted slightly, if at all, because the user still knows to look for the site information box 304 above the PIN pad 302. In fact, some users might not even realize that the layout 400 is different than the prior layout 300. By presenting the site information box 304 in a different position, however, the layout 400 may prevent third parties from accessing the information displayed therein because such third parties may be monitoring the position of the box 304 in the prior layout 300 rather than the new position of the box 304 in the current layout 400.

FIG. 5 is a block diagram illustrating a third example of a user interface layout 500 including a PIN pad 502, such as the PIN pad 302 in the layout 300 of FIG. 3, in accordance with certain embodiments of the disclosed technology. The layout 500 also includes a site information box 504, such as the site information box 304 in the layout 300 of FIG. 3.

FIG. 6 is a block diagram illustrating a fourth example of a user interface layout 600 representing a repositioning of the PIN pad 502 and site information box 504 in the layout 500 of FIG. 5 in accordance with certain embodiments of the disclosed technology. In situations where the layout 500 of FIG. 5 had been presented previously, e.g., for the last user interaction or for the last interaction for a particular user, the layout 600 of FIG. 6 may be subsequently presented instead of the layout 500 of FIG. 5, e.g., for the next user interaction or for the next interaction with a particular user.

As can be readily ascertained from looking at the layouts 500 and 600 of FIGS. 5 and 6, respectively, the PLN pad 502 remains in the same position but the site information box 504 has shifted horizontally. As with the layouts 300 and 400 of FIGS. 3 and 4, respectively, the ease of use in the present example is impacted slightly, if at all, because the user still knows to look for the site information box 504 in the same general area with respect to the PIN pad 502 and some users might not even realize that the layout 600 is different than the prior layout 500. As with the example illustrated by FIGS. 3 and 4, presentation of the site information box 504 in a different position in the current layout 600 than in the prior layout 500 may prevent third parties from accessing the information displayed therein because such third parties likely expect the position of the box 504 to stay the same.

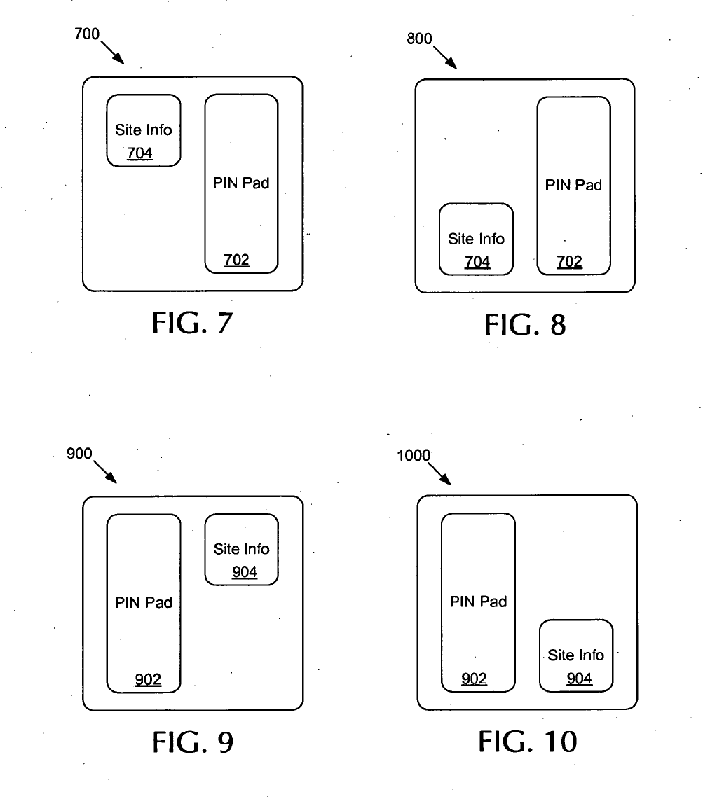

FIG. 7 is a block diagram illustrating a fifth example of a user interface layout 700 including a PIN pad 702, such as the PIN pad 302 in the layout 300 of FIG. 3, in accordance with certain embodiments of the disclosed technology. The layout 700 also includes a site information box 704, such as the site information box 304 in the layout 300 of FIG. 3.

FIG. 8 is a block diagram illustrating a sixth example of a user interface layout 800 representing a repositioning of the PIN pad 702 and site information box 704 in the layout 700 of FIG. 7 in accordance with certain embodiments of the disclosed technology. In situations where the layout 700 of FIG. 7 had been presented previously, e.g., for the last user interaction or for the last interaction for a particular user, the layout 800 of FIG. 8 may be subsequently presented instead of the layout 700 of FIG. 7, e.g., for the next user interaction or for the next interaction with a particular user.

As can be readily ascertained from looking at the layouts 700 and 800 of FIGS. 7 and 8, respectively, the PIN pad 702 remains in the same position but the site information box 704 has shifted vertically. The ease of use is impacted slightly, if at all, because the user still knows to look for the site information box 304 to the left of the PIN pad 302. In fact, some users might not even realize that the layout 800 is different than the prior layout 700. By presenting the site information box 704 in a different position, however, the layout 800 may prevent third parties from accessing the information displayed therein because such third parties may be monitoring the position of the box 704 in the prior layout 700 rather than the new position of the box 704 in the current layout 800.

FIG. 9 is a block diagram illustrating a seventh example of a user interface layout 900 including a PIN pad 902, such as the PIN pad 302 in the layout 300 of FIG. 3, in accordance with certain embodiments of the disclosed technology. The layout 900 also includes a site information box 904, such as the site information box 304 in the layout 300 of FIG. 3.

FIG. 10 is a block diagram illustrating an eighth example of a user interface layout 1000 representing a repositioning of the PIN pad 902 and site information box 904 in the layout 900 of FIG. 9 in accordance with certain embodiments of the disclosed technology. In situations where the layout 900 of FIG. 9 had been presented previously, e.g., for the last user interaction or for the last interaction for a particular user, the layout 1000 of FIG. 10 may be subsequently presented instead of the layout 900 of FIG. 9, e.g., for the next user interaction or for the next interaction with a particular user.

As can be readily ascertained from looking at the layouts 900 and 1000 of FIGS. 9 and 10, respectively, the PIN pad 902 remains in the same position but the site information box 904 has shifted vertically. As with the layouts 700 and 800 of FIGS. 7 and 8, respectively, the ease of use in the present example is impacted slightly, if at all, because the user still knows to look for the site information box 904 in the same general area with respect to the PIN pad 902 and some users might not even realize that the layout 1000 is different than the prior layout 900. As with the example illustrated by FIGS. 7 and 8, presentation of the site information box 904 in a different position in the current layout 1000 than in the prior layout 900 may prevent third parties from accessing the information displayed therein because such third parties likely expect the position of the box 904 to stay the same.

In certain embodiments, visual cues may be displayed over a secure channel between a secure interface element and the display of the computing device to make it more difficult for an adversary to reproduce them in malware. The visual cues may be used to detect overlaps and facilitate identification of important information. Such visual cues may include, but are not limited to, background pattern, font, color, and orientation. Alternatively or in addition thereto, the visual cues may include size, shape, color, and gradient of interface elements as well as spacing between two or more such elements.

In certain embodiments, a visual cue may include user-selected anti-spoofing elements such as a predetermined or user-generated image, a pet name, a childhood-related piece of information such as high school graduated from, a favorite phrase, etc. Alternatively or in addition thereto, important information may be embedded inside user inputs to defeat overlaps by malware.

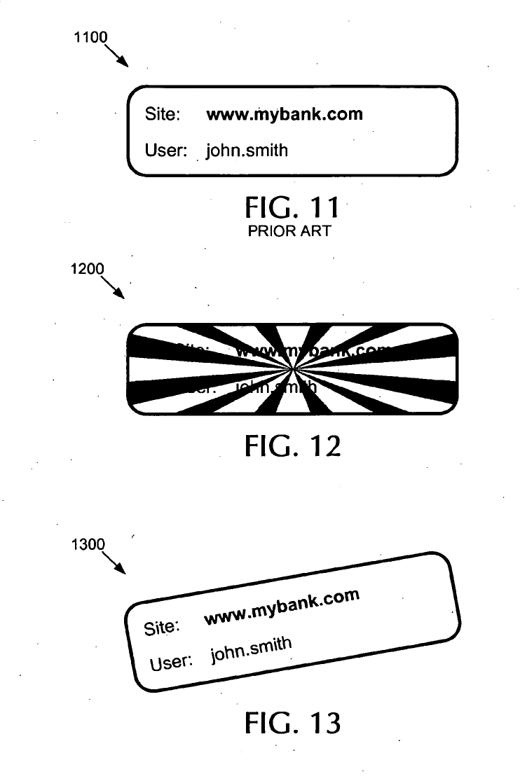

FIG. 11 is a block diagram illustrating an example of a current site information box 1100 of a user interface in accordance with certain embodiments of the disclosed technology. In the example, a user can enter information pertaining to site into which he or she seeks to log-in, here www.mybank.com, along with the user's name, here John Smith.

FIG. 12 is a block diagram illustrating a first example of a site information box 1200 of a user interface implementing a visual cue in accordance with certain embodiments of the disclosed technology. In situations where a different site information box, such as the site information box 1100 of FIG. 11, had been presented previously, e.g., for the last user interaction or for the last interaction for a particular user, the site information box 1200 of FIG. 12 may be subsequently presented instead of the previously presented site information box, e.g., for the next user interaction or for the next interaction with a particular user. In the example, the visual cue includes a background pattern that does not prevent a user from seeing the displayed information but may serve to prevent a third party, e.g., malware, from recognizing and/or capturing the displayed information.

FIG. 13 is a block diagram illustrating a second example of a site information box 1300 of a user interface implementing a visual cue in accordance with certain embodiments of the disclosed technology. In situations where a different site information box, such as either of the site information boxes 1100 and 1200 of FIGS. 11 and 12, respectively, had been presented previously, e.g., for the last user interaction or for the last interaction for a particular user, the site information box 1300 of FIG. 13 may be subsequently presented instead of the previously presented site information box, e.g., for the next user interaction or for the next interaction with a particular user. In the example, the visual cue includes a repositioning of the entire site information box 1300 that, like the site information box 1200 of FIG. 12, does not prevent a user from seeing the displayed information but may serve to prevent a third party from recognizing and/or capturing the displayed information.

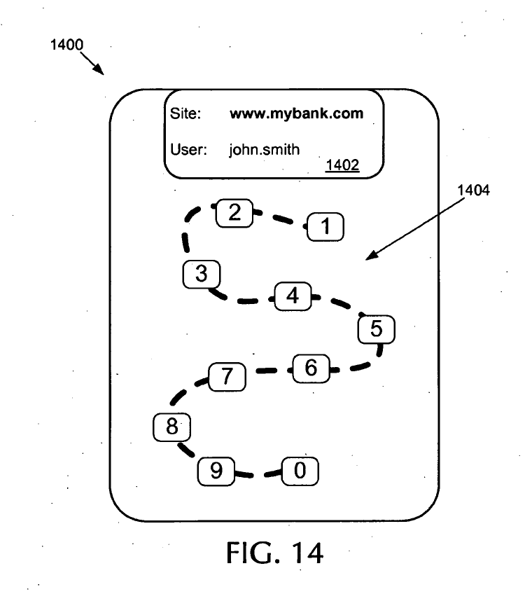

FIG. 14 is a block diagram illustrating an example of a user log-in interface 1400 in accordance with certain embodiments of the disclosed technology. The user log-in interface 1400 includes a site information box 1402 and a virtual keypad 1404, which may be implemented as a touch-sensitive panel displayed on a screen. In the example, a keypad 1404 is visually presented in a randomized manner with a dashed line to make it easier for a user to find whatever number he or she wishes to select while making it significantly more difficult for a third party to capture whatever information the user provides by way of the virtual keypad 1404.

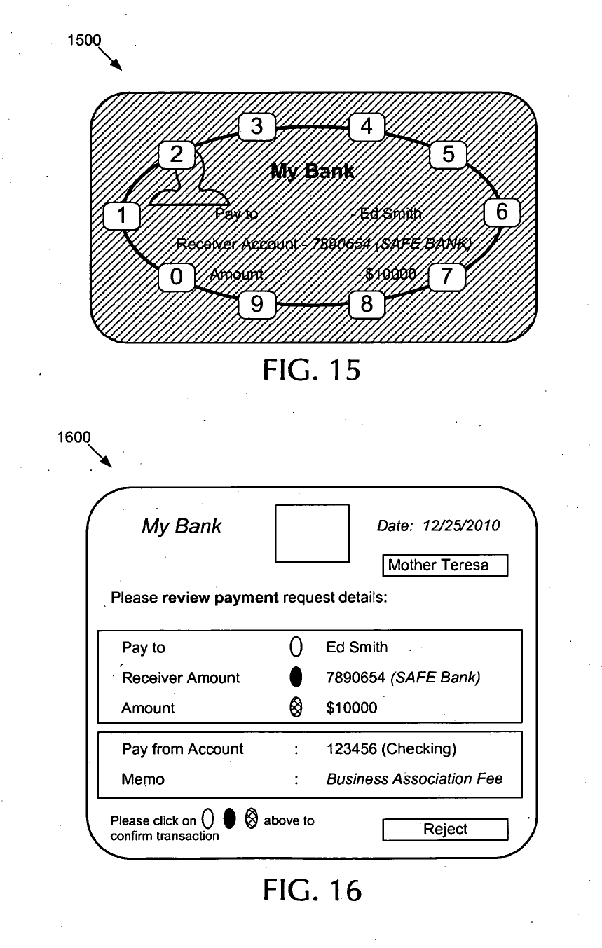

FIG. 15 is a block diagram illustrating a first example of a payment confirmation user interface 1500 in accordance with certain embodiments of the disclosed technology. The payment confirmation interface 1500 includes a virtual keypad that is visually presented in a randomized manner with a line connecting each number to the corresponding adjoining numbers to make it easier for a user to find whatever number he or she wishes to select while making it significantly more difficult for a third party to capture whatever information the user provides by way of the virtual keypad. In the example, the payment confirmation interface 1500 also implements a background pattern to further enhance protection of the user-provided information from third party attacks such as malware.

FIG. 16 is a block diagram illustrating a second example of a payment confirmation user interface 1600 in accordance with certain embodiments of the disclosed technology. In the example, three icons are presented next to the information to be confirmed and a key is provided. specifying an order in which the user must select the icons in order for the transaction to be confirmed. While this technique may slightly increase complexity of use for some users, it will likely improve protection of the information against third party attacks significantly.

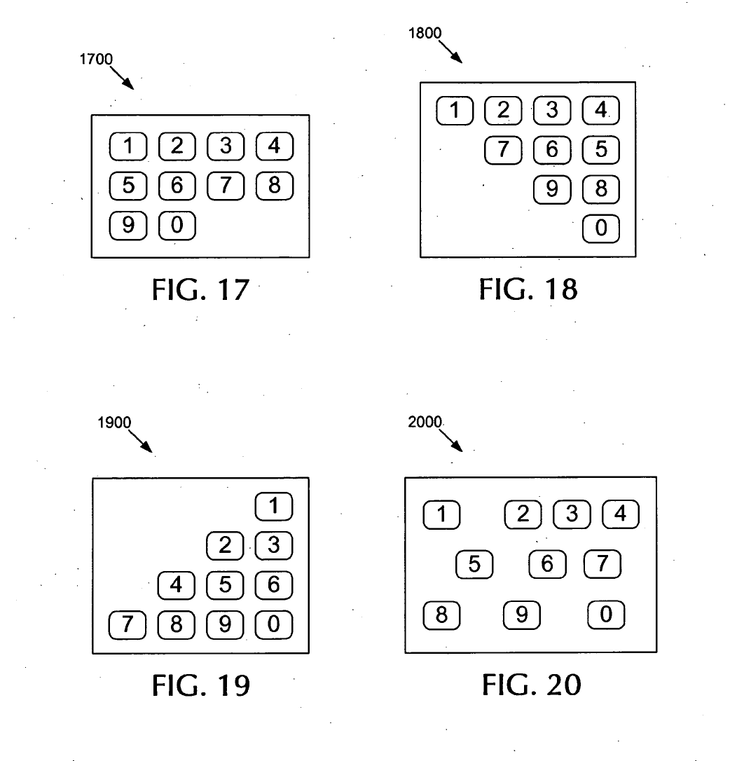

FIG. 17 is a block diagram illustrating a first example of a numeric keypad layout 1700 in accordance with certain embodiments of the disclosed technology. The layout 1700 may be implemented as a virtual keypad on a touchscreen. In the example, the virtual keys are presented in increasing numeric order from left to right but the layout 1700 is asymmetrical in appearance. 20. While the impact to a user will be minimal, if at all, the randomized appearance of the keypad will greatly enhance protection against third parties seeking to capture information entered by a user via the virtual keypad.

FIG. 18 is a block diagram illustrating a second example of a numeric keypad layout 1800 in accordance with certain embodiments of the disclosed technology. The layout 1800 may be implemented as a virtual keypad on a touchscreen. Unlike the layout 1700 of FIG. 17, the virtual keys in the layout 1800 are not all presented in increasing numeric order from left to right. Indeed, two of the rows are presented in decreasing numeric order from left to right. While the impact to a user may be slightly more so than with the layout 1700 of FIG. 17, the randomized appearance will still greatly enhance protection against third parties seeking to capture information entered by a user via the virtual keypad, perhaps more so than with the layout 1700 of FIG. 17.

FIG. 19 is a block diagram illustrating a third example of a numeric keypad layout 1900 in accordance with certain embodiments of the disclosed technology. The layout 1900 may be implemented as a virtual keypad on a touchscreen. The layout 1900 is similar to the layout 1700 of FIG. 17 in that the virtual keys are presented in increasing numeric order from left to right and the overall appearance is asymmetrical but, unlike the layout 1700 of FIG. 17, the layout 1900 does not have any row with the same number of keys as another row nor does it have a column with the same number of keys as another column. As with the layout 1700 of FIG. 17, the impact of the layout 1900 to a user will be minimal, if at all, but it will greatly enhance protection against third parties seeking to capture information entered by a user via the virtual keypad.

FIG. 20 is a block diagram illustrating a fourth example of a numeric keypad layout 2000 in accordance with certain embodiments of the disclosed technology. The layout 2000 may be implemented as a virtual keypad on a touchscreen. In the example, the virtual keys are presented in increasing numeric order from left to right and the overall appearance of the layout 2000 is asymmetrical but, unlike any of the layouts 1700-1900 of FIGS. 17-19, respectively, the layout 2000 does not have an ordered row/column format. Consequently, the layout 2000 may provide even greater protection against third party attacks than the layouts 1700-1900 of FIGS. 17-19, respectively.

Certain implementations of the disclosed technology involve techniques for defining layouts and using an algorithm to estimate how much randomness a set of user interface layouts offers to calculate the probability of an attacker guessing the location of selected user interface elements. Designers can then use this information to optimize a user interface layout to make it consistent from a user's perspective.

In certain embodiments, a secure window may be divided into a grid size of a specified resolution. Each grid location may be assigned a unique identifier an with an associated counter g_{ci}. A layout Lᵢ can be selected from a layout set L{ } that contains layout definitions, absolute/relative positions of user interface elements U { }, orientation, z-order, usability constraints such as vertical/horizontal alignments, paddings, margins, etc. For each of Nᵢ iterations, a layout pattern Pᵢ may be created by placing user interface elements within the layout with allowed constraints, the layout Pᵢ may be placed in all valid locations in a secure window W{ }, and the grid count g_{ci} may be incremented when Uᵢ is completely or partially in the grid g{ }. An analysis of grid count g_{ci} distribution may provide locations with grids having a relatively high probability of being guessed by attackers. Patterns showing location affinity for given entropy may be removed.

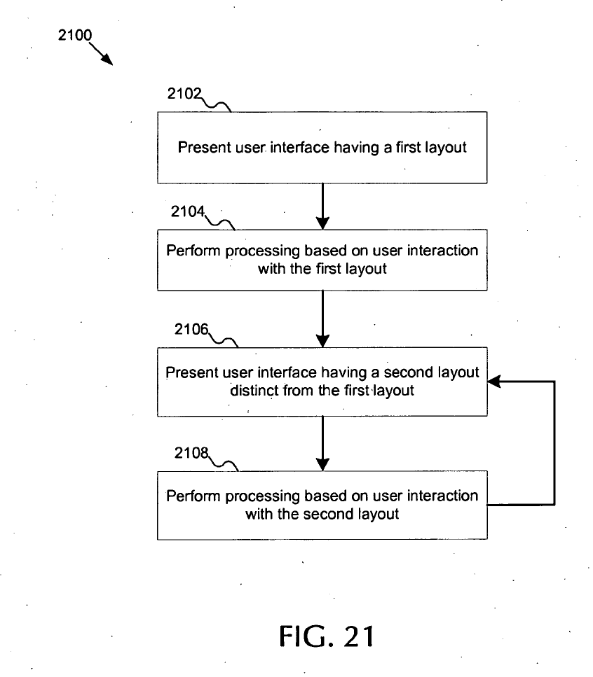

FIG. 21 is a flowchart illustrating an example of a machine-controlled method 2100 for providing a secure user interface in accordance with certain embodiments of the disclosed technology. At 2102, a user interface having a first layout is presented to a user. For example, a user interface layout such as the user interface layout 300 of FIG. 3 may be visually displayed to the user.

At 2104, processing is performed responsive to user interaction with the user interface. For example, if the user enters login information, the system or device may confirm whether the login information is valid. Alternatively, if the user is confirming a financial transaction, the system or device may determine based on the user interaction whether the financial transaction has been sufficiently validated.

At 2106, a user interface having a second layout distinct from the first layout is presented to a user. In certain embodiments, the second layout is presented in connection with the next user interaction with the system or device, regardless of the user's identity. In other embodiments, the second layout is presented based on a determination that, during the last interaction with the user, the first layout was presented to the user.

At 2108, processing is performed responsive to user interaction with the user interface. For example, as with the processing performed at 2104, the system or device may confirm whether user login information is valid or determine whether a financial transaction request has been validated. In the example, the method 2100 returns to 2106 except that, with each iteration, the “second layout” is generally distinct from the previous layout. In other words, the method 2100 generally includes the presenting of a first layout followed by a second layout followed by a third layout, etc.

In certain embodiments, some of the layouts may be similar or even identical to each other but such is usually not the case with successive layouts. For example, a tenth layout may be similar or identical to the third layout but not the ninth or eleventh layouts. An exception may occur, however, in the case of different users. For example, a tenth layout may be similar or identical to the ninth layout if each of the two layouts were presented to distinct users during separate sessions with the user interface. Such ability to reuse layouts may lead to improved efficiency of the method 2100.

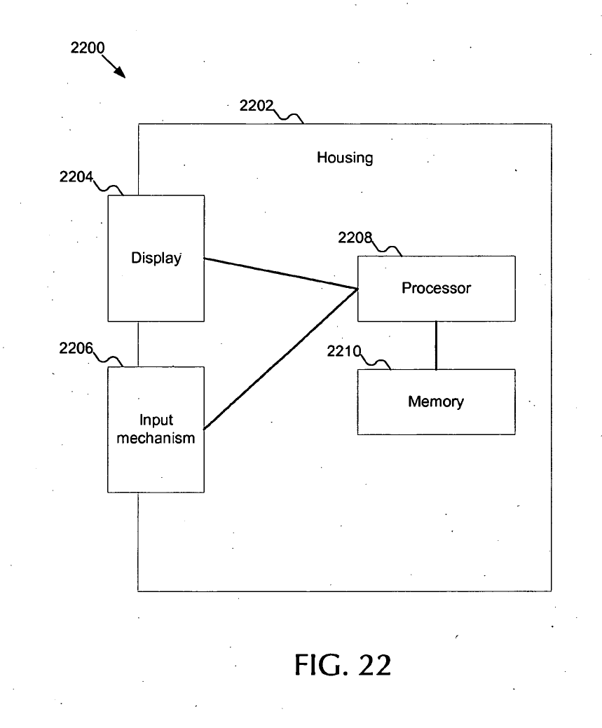

FIG. 22 illustrates an example of a system 2200 in which embodiments of the disclosed technology may be implemented. The system 2200 may include, but is not limited to, a computing device such as a laptop computer, a mobile device such as a handheld or tablet computer, a communications device such as a smartphone, or an industry-specific machine such as a kiosk or ATM. The system 2200 includes a housing 2202, a display 2204 in association with the housing 2202, an input mechanism 2206 in association with the housing 2202, a processor 2208 within the housing 2202, and a memory 2210 within the housing 2202. The input mechanism 2206 may include a physical device, such as a keyboard, or a virtual device, such as a virtual keypad implemented within a touchscreen. The processor 2208 may perform virtually any of or any combination of the various operations described above. The memory 2210 may store information resulting from processing performed by the processor 2208.

Embodiments of the disclosed technology may be incorporated in various types of architectures. For example, certain embodiments may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. A machine-controlled method, comprising:
visually presenting to a first user a first user interface for a first transaction involving user-sensitive information, the first user interface having a first user interface layout;
performing processing based on user-sensitive information received by way of user interaction by the first user with the first user interface; and
visually presenting to a second user a second user interface for receiving a second transaction involving user-sensitive information, the second user interface having a second user interface layout that is visually distinct from the first user interface layout.

2. The machine-controlled method of claim 1, wherein the second user interface layout is based at least in part on a determination as to whether the second user is the first user.

3. The machine-controlled method of claim 1, wherein the second transaction occurs subsequent to the first transaction.

4. The machine-controlled method of claim 3, wherein there are no intervening transactions between the first and second transactions.

5. The machine-controlled method of claim 1, wherein the first user interface comprises a first PIN pad and a first site information box, and wherein the second user interface comprises a second PIN pad and a second site information box, the second user interface having a desired level of entropy.

6. The machine-controlled method of claim 5, wherein the first PIN pad has a first PIN pad position within the first user interface layout, wherein the second PIN pad has a second PIN pad position within the second user interface layout, and wherein the first PIN pad location is at least substantially identical to the second PIN pad location.

7. The machine-controlled method of claim 5, wherein the first site information box has a first site information box position within the first user interface layout, wherein the second site information box has a second site information box position within the second user interface layout, and wherein the first site information box position is visually distinct from the second site information box position.

8. The machine-controlled method of claim 7, wherein the second site information box position is situated at least substantially horizontally from the first site information box position.

9. The machine-controlled method of claim 8, wherein the second site information box position is situated at least substantially vertically from the first site information box position.

10. The method of claim 5, wherein the first site information box has a first site orientation within the first user interface layout, wherein the second site information box has, a second site orientation within the second user interface layout, and wherein the first site information box orientation is visually distinct from the second site information box orientation.

11. The method of claim 10, wherein the first site orientation is at least substantially horizontal, and wherein the second site orientation is at least noticeably non-horizontal.

12. The method of claim 1, wherein the first user interface comprises a first keypad having a first keypad layout, and wherein the second user interface comprises a second keypad having a second keypad layout that is visually distinct from the first keypad layout.

13. The method of claim 12, wherein the second keypad layout comprises a plurality of keys presented in a randomized order.

14. The method of claim 1, wherein the second user interface comprises a visual cue that includes at least one of a group consisting of: a background pattern, a particular font of at least one element of the second user interface, a particular color of at least one element of the second user interface, and a particular orientation of at least one element of the second user interface.

15. The method of claim 1, wherein the second user interface comprises a visual cue that includes at least one of a group consisting of a particular size of at least one element of the second user interface, a particular shape of at least one element of the second user interface, and a particular gradient of at least one element of the second user interface.

16. A non-transitory computer-readable medium storing instructions that, when executed by a processor, cause the processor to:
visually present to a first user a first user interface for a first transaction involving user-sensitive information, the first user interface having a first user interface layout;
perform processing based on user-sensitive information received by way of user interaction by the first user with the first user interface; and
visually present to a second user a second user interface for receiving a second transaction involving user-sensitive information, the second user interface having a second user interface layout that is visually distinct from the first user interface layout.

17. The non-transitory computer-readable medium of claim 16, wherein the first user interface comprises a first PIN pad and a first site information box, and wherein the second user interface comprises a second PIN pad and a second site information box.

18. The non-transitory computer-readable medium of claim 17, wherein the first site information box has a first site information box position within the first user interface layout, wherein the second Site information box has a second site information box position within the second user interface layout, and wherein the first site information box position is visually distinct from the second site information box position.

19. The non-transitory computer-readable medium of claim 17, wherein the first site information box has a first site orientation within the first user interface layout, wherein the second site information box has a second site orientation within the second user interface layout, and wherein the first site information box orientation is visually distinct from the second site information box orientation.

20. The non-transitory computer-readable medium of claim 16, wherein the first user interface comprises a first keypad having a first keypad layout, and wherein the second user interface comprises a second keypad having a second keypad layout that is visually distinct from the first keypad layout.

21. An apparatus, comprising:
an input mechanism configured to receive input from users;
a display configured to visually present user interfaces to users; and
a processor configured to:
cause the display to visually present to a first user a first user interface for a first transaction involving user-sensitive information, the first user interface having a first user interface layout;
perform processing based on user-sensitive information received by way of user interaction by the first user with the first user interface via the input mechanism; and
cause the display to visually present to a second user a second user interface for receiving a second transaction involving user-sensitive information, the second user interface having a second user interface layout that is visually distinct from the first user interface layout.

22. The apparatus of claim 21, wherein the first user interface comprises a first PIN pad and a first site information box, and wherein the second user interface comprises a second PIN pad and a second site information box.

23. The apparatus of claim 22, wherein the first site information box has a first site information box position within the first user interface layout, wherein the second site information box has a second site information box position within the second user interface layout, and wherein the first site information box position is visually distinct from the second site information box position.

24. The apparatus of claim 22, wherein the first site information box has a first site orientation within the first user interface layout, wherein the second site information box has a second site orientation within the second user interface layout, and wherein the first site information box orientation is visually distinct from the second site information box orientation.

25. The apparatus of claim 21, wherein the first user interface comprises a first keypad having a first keypad layout, and wherein the second user interface comprises a second keypad having a second keypad layout that is visually distinct from the first keypad layout.
